(19) United States
(12) Patent Application Publication
(10) Pub. No.: US 2014/0128043 A1
(43) Pub. Date: May 8, 2014

(54) METHOD AND SYSTEM FOR RICH MEDIA ENABLED IP PHONE, COMMUNICATION DEVICE, SOFTWARE AND SERVICES FOR CUSTOMER SERVICE, CONFERENCING AND OTHER BUSINESS COMMUNICATIONS

(71) Applicant: Pathway Innovations and Technologies, Inc., San Diego, CA (US)

(72) Inventor: Ji Shen, San Diego, CA (US)

(73) Assignee: Pathway Innovations and Technologies, Inc., San Diego, CA (US)

(21) Appl. No.: 14/122,020

(22) PCT Filed: May 25, 2012
(86) PCT No.: PCT/US12/39522

§ 371 Date: Jan. 24, 2014

Related U.S. Application Data
(60) Provisional application No. 61/489,843, filed on May 25, 2011.

(51) Int. Cl. H04W 4/16

(52) U.S. Cl. CPC H04W 4/16
USPC 455/414.1

(57) ABSTRACT

Disclosed are embodiments of a system for rich media enabled communication that includes a service server system and a rich media enabled interactive telephonic device (RMITD). The service server system is configured to initiate a system sharing session automatically upon initiation of a phone call with the rich media enabled interactive telephone device. The RMITD has a browser enabled to access the service server system. The browser can be dynamically downloaded or downloaded in real time from a remote server. The system sharing session is a session in which the service system has access to the RMITD's processor.

This application is related to and claims the benefit under 35 U.S.C. §119 of International Application No. PCT/US2012/039522, filed May 25, 2012, and Provisional Application No. 61/489,843, filed on May 25, 2011, the contents of each are herein incorporated by reference in their entirety.

### FIELD

The present subject matter relates to rich media enabled communication.

### BACKGROUND

Today's telephone(s), especially landline telephone devices that are used by businesses, only carry voice. This can be limiting in many business situations.

In one example, when a customer service call comes in, for example, for the purpose of ordering a pizza, all information such as delivery address and menu item choices, is only conveyed orally. The process is time consuming, ineffective, and error prone. It is much more desirable to communicate with customers with voice, textual data, video, and interactive web applications simultaneously. The worker taking the order should be able to present to the customer an interactive menu with or without special promotions, and complete the order with a single click on either side, while the customer can type in the delivery address during the call or even before initiating the call.

In another example, in a customer call made to a gadget manufacturer service representative, for example, about a defective unit shipped to him that was inoperative or defective on arrival, the customer must typically go through a series of (automated, template or decision-tree guided) questions and make responsive answers before the service representative can determine whether the call incident qualifies for a full refund or exchange. Instead, it would be much more desirable for the customer to simply pick-up or activate a smartphone, tablet, computer or other camera-enabled device to transmit a live video stream to the service representative so that the problem can be described with both voice and data.

In another example, a software application vendor's customer service representative can receive an interactive call from a customer in front of their computer. Typically, service representatives can only guide the customer verbally and receive feedback or confirmation from the customer (also verbally) while the customer operates his/her computer Today, the service representative can only answer the phone, then make a “date” with the customer to get on a third party remote desktop sharing service to help. Instead, the service call would be much more efficient if the screen sharing can be initiated right at the moment the customer calls in. The service representative should be able to demonstrate or train the customer on the spot, or play a video clip for the customer to answer questions much more clearly.

However, today's telephones, even including smartphones like the iPhone™ and Android™, are incapable of and do not truly facilitate such fully interactive communications. The present subject matter solves many problems of existing technology.

For example, Landline phones and cell phones do not offer a fully interactive rich media communication to truly facilitate a virtual presence. Video phones are emerging technologies and increasing in usage, but video phones typically require parties on the call to be using the same device, or at least the same protocol of communication. This creates a closed system with a deadlocked “chicken-and-egg” problem. Without a universally applicable ecosystem, rich media enabled phone communication will not be adopted on a wide spread basis for a long time. Even video phones are not truly interactive. There is no simultaneous textual data being transmitted, nor are there fully interactive applications to enable both parties to “click” on at the same time to facilitate the most efficient and truly interactive communication.

### SUMMARY

Instead of relying on only hardware devices on both ends of communication, or relying on only software applications, the present subject matter employs, in one example, a dedicated interactive telephone device based on a full tablet computer platform working in conjunction with software client terminals.

The present subject matter overcomes the problems hindering truly interactive communication between two parties. Existing technology normally requires communications apparatuses to be used in matching pairs, which hinders wide spread adoption and creates barriers to technology due to cost, and availability. Previous technology addressed only software, or only hardware, and not both. Previous hardware is normally only an embedded system with limited and specialized functionality. There is a low level of interactive capability. There was no means for running software applications, or sharing of each other's screens, nor for virtually anything like HTML or dynamic forms. Screen sharing software applications require installation and compatibility of software on the user's system. Previous software was platform specific, i.e. personal computer (PC) or Mac, and relied on proper configuration and installation on a supporting computer. This reliance on a computer further diminished the portability and usability of any communication technology.

In contrast, the subject matter discussed herein is not limited to a specific device, platform or software. No matched pair or set is required for use. The subject matter addresses and builds on software and hardware of both client/customer and business in creating truly interactive communications. The level of interactive capability is essentially limitless. Means are provided for running software applications, sharing of each other's screens, and dynamic information forms such as HTML, JAVA, etc. are fully supported. Computing, space and storage requirements of the subject matter system are minimal and generally attributable to features and programs of the existing supporting hardware and software executed by the user.

One embodiment of a system for rich media enabled communication includes a service server system and a rich media enabled interactive telephonic device (RMITD). In one embodiment, the service server system is configured to initiate a system sharing session automatically upon initiation of a phone call with the rich media enabled interactive telephone device. The RMITD has a browser enabled to access the service server system. The browser can be dynamically downloaded or downloaded in real time from a remote server. The system sharing session is a session in which the service system has access to the RMITD's processor.

The interactive telephonic device is one of a tablet computer, an audio and visual receiving and transmission device, a processor, a display, an input keyboard, and a smart phone device. The service system is a web service system that can be one or a combination of a directory server for locating entries, a switchboard for routing communication, a database of directory information, or a host of websites comprising the directory information.

The websites are any of an entry site, which can be a directory of a number of searchable registered business entries, information sites, which can be business profiles, rich media content, or fully interactive web applications, and software for initiating communication with a desired entry site. The software is primarily stored on the host server and accessible by users. Each business entry would include a contact telephone number for communication with the interactive telephone device. The act of selecting a contact telephone number simultaneously enables access to a business's sever and initiates telephone contact with the business.

A further embodiment of a system for rich media enabled communication includes a web service server system and a rich media enabled interactive telephonic device (RMITD). The RMITD has a browser and an application downloaded and configurable for accessing the web service server system. The RMITD is configured to initiate a screen sharing session automatically upon initiation of a phone call with the web service server system. The system sharing session is a session in which the RMITD has access to the service system's processor or host server.

Web server systems are any of an entry site or an information site. Entry sites can be directories of searchable registered customer entries. Information sites can be customer profiles, rich media content, or fully interactive web applications. Software for initiating communication with a desired entry site is primarily stored on the host server and accessible by users. Each customer entry has a contact telephone number for communication with the interactive telephone device. Selection of the contact telephone numbers simultaneously enables access to a RMITD's processor and telephone contact with the customer.

A method for rich media enabled communication includes accessing a directory of businesses, locating a rich media enabled contact number corresponding to a business in the directory and dialing the rich media enabled contact number, establishing a telephonic and data connection; and displaying media content associated with the business. Screen sharing between the business and a caller is initiated simultaneously with establishing the telephonic and data connection.

Dialing the rich media enabled contact number occurs on an interactive telephonic device that is selected from the group consisting of a tablet computer, an audio receiving and transmission device, a processor, a display, an input keyboard, and a smart phone device.

### BRIEF DESCRIPTION OF THE SEVERAL VIEWS OF THE DRAWINGS

FIG. 1 shows an example communication between connected devices of an example system;

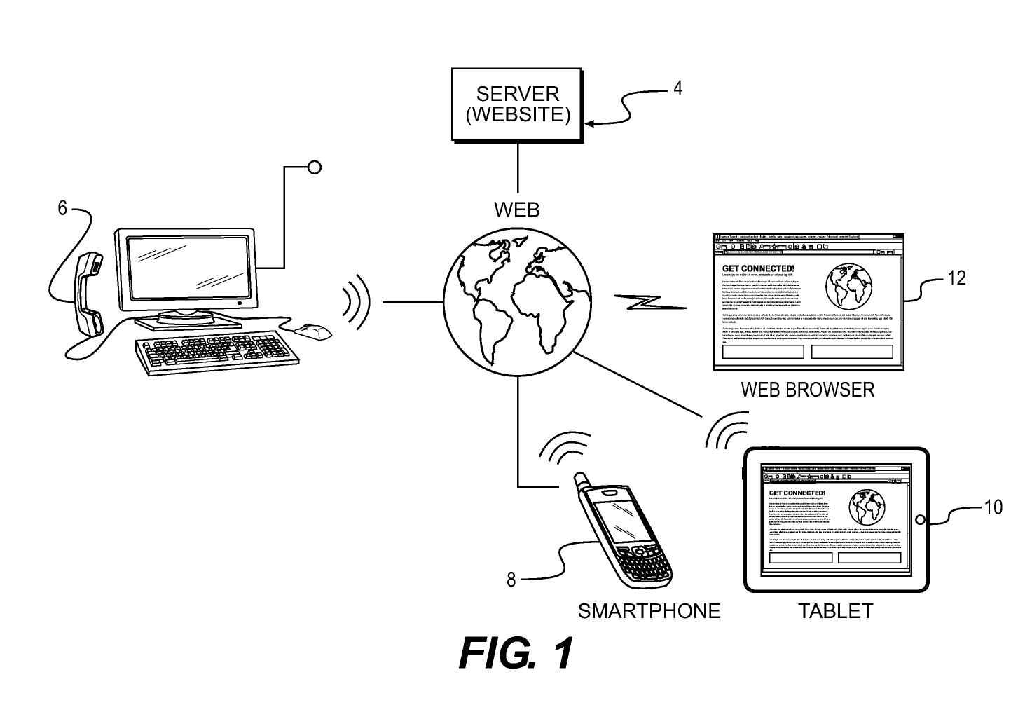

FIG. 2 shows an example of a central server connecting devices of an example system;

FIG. 3 shows an example of peer to peer connected devices of an example system; and

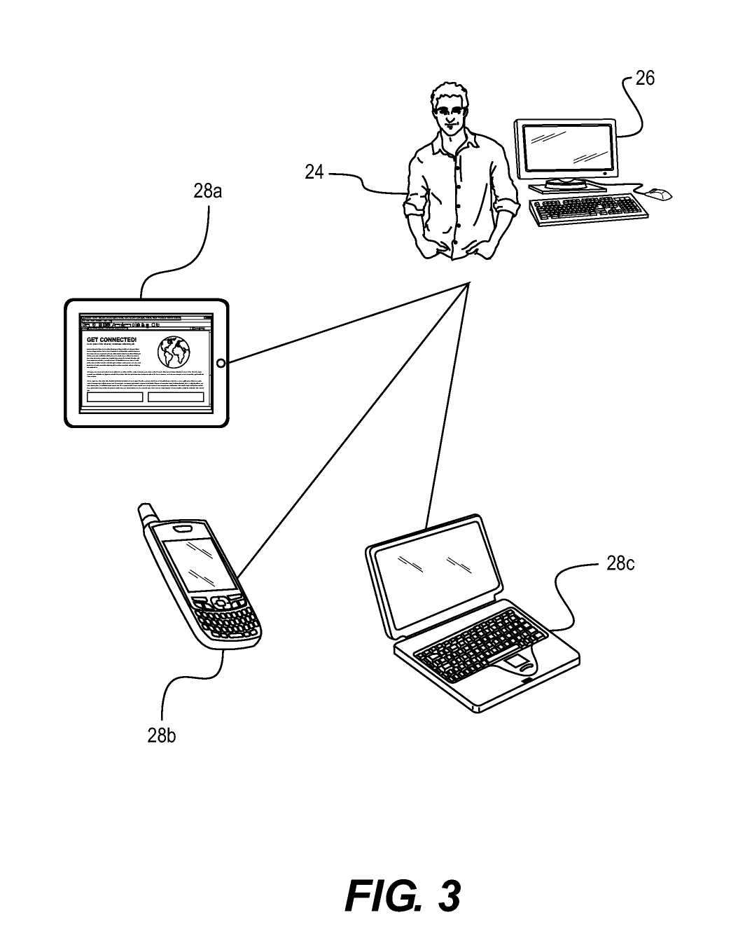

FIG. 4 is a flowchart showing steps of a method disclosed herein.

### DETAILED DESCRIPTION

A first embodiment 2 of a system for rich media enabled communication includes a service server system 4 and a rich media enabled interactive telephonic device (RMITD) such as a computer 6 a smart phone 8 or a tablet 10. The service server system 4 is configured to initiate a system sharing session automatically upon initiation of a phone call with the rich media enabled interactive telephone device. The RMITD has access to a virtual browser 12 or the device itself has a browser that is enabled to access the service server system 4. The content shared or viewable between the users during a communication can be dynamically updated or updated in real time. The dynamic updates can be refreshed by request, at a predetermined or customizable interval, and can be further “pushed” at the request of one or both user parties. In this manner, dynamic functionality is provided.

The RMITD includes an audio and visual receiving and transmission device, i.e., speakers, a document camera or other imaging device and a microphone, a processor, a display, and a further input such as a keyboard or a mouse. Alternatively, a type of telephone that combines the features of a tablet computer, including, for example, a speaker and/or headset (which may be wired, wireless, Bluetooth protocol connected, etc.), a large screen, a (preferably full-size) keyboard and with an integrated camera can be used.

A caller can initiate a call from a browser or another software application. The software application can be any software application able to initiate calls, or can be a specialized application optimized for the subject matter. No special piece of hardware for video phone call or other rich media calls is necessary to initiate the call.

The present subject matter employs, in one example, an RMITD, which is a dedicated interactive telephone device that is based on a full tablet computer platform working in conjunction with software client terminals running on virtually any computing device in browsers as static html pages, or with Rich Internet Applications (such as HTML5, JavaScript, Flex, etc.) or in mobile application software. Such an RMITD is Internet Protocol (IP) connected to the world wide web only. Tablets or smart phone devices initiate calls through applications downloaded on the device, or use built-in mobile browsers to connect to an RMITD.

Once communication has been initiated, the users, for example, a service representative, can share his or her screen as a presenter or the caller can share his/her screen as a presenter as well, depending on the specific situation and desired functionality by the users. Accordingly, textual, video, voice, software applications (for example Rich Internet Applications RIA), html static pages, forms, etc. can all be shared between the calling parties, all at the same time.

The system sharing session is a session in which the service system 4 has access to the RMITD's processor. The service system 4 is a web service system that is one or a combination of a directory server for locating entries, a switchboard for routing communication, a database of directory information, or a host of websites comprising the directory information. The benefit is that a customer or caller to a website operator can access the website's files while conducting a conversation with a customer service representative. In this case, the user is not limited to the content provided on the website, but the user can essentially control the processes of the remote server that hosts the website. Thus, if there is information that is not typically provided by a website to a person who is a web viewer, the person can dig deeper in the host server files to find the necessary information.

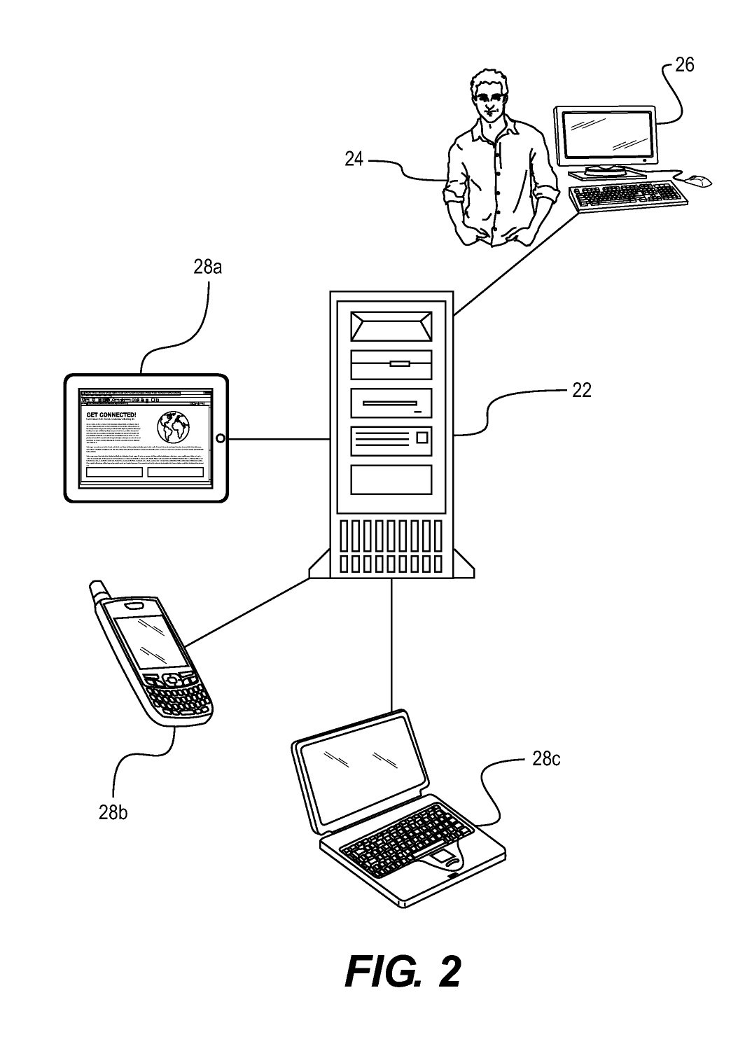

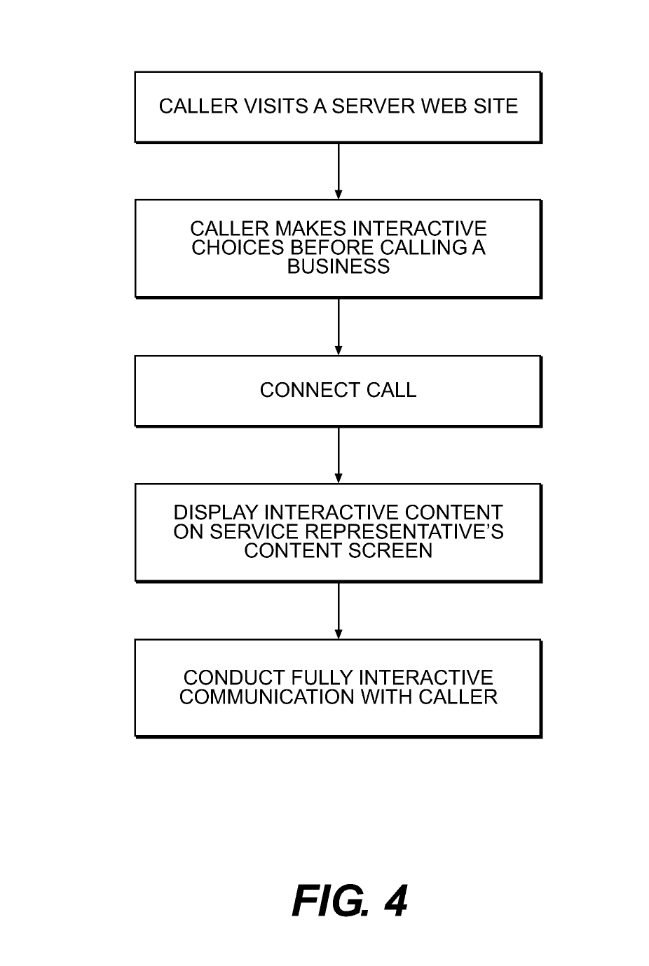

As shown in FIG. 2, the communication may be hosted through an intermediate server 22 for the duration of the call wherein a customer service person 24 operates a terminal 26 to communicate with customer devices 28a, 28b, and 28c, to create an initial connection or “handshake” only. Or, as shown in FIG. 4, the connection may be peer-to-peer for the complete duration of the communication. One of the users in this or any other embodiment may “host” the communication and have more or less control over the presentation or sharing of data or information.

The connection of the two users creates a “unique” site viewable only to the users in the communication. Both the site and the communication is secure and subsequent interaction (including content) is viewable only to the users in the communication and cannot be accessed by other parties, whether they are consumers, businesses, searching in the directory, etc.

The websites are any of an entry site, which can be a directory of a number of searchable registered business entries, information sites, which can be business profiles, rich media content, or fully interactive web applications, and software for initiating communication with a desired entry site. The software is primarily stored on the host server and accessible by users. Each business entry would include a contact telephone number for communication with the interactive telephone device. The act of selecting a contact telephone number simultaneously enables access to a business's sever and initiates telephone contact with the business.

The subject matter provides increased functionality and interactivity over any PSTN (Plain and Simple Telephone Network) phone—which is voice only and builds on the basic technology offered by existing technologies such as cell phones, video phones and screen sharing software applications (GoToMeeting, WebEx, Skype, etc.). Cell phones are limited by the features offered by the cell phone carrier, whereas video phones require both parties to have the same or at least compatible video phones.

A web services server system functions as a directory server/switch board for locating and routing a call to an RMITD. In one contemplated example, an RMITD can be identified as a special character prefixed to a regular telephone number, which is normally associated with a business (such as the business's customer support line). Alternatively, the phone number will be a number assigned to a business RMITD within the system.

A web services server system also functions as a web site where callers can visit through any browser, search for a registered business, and initiate a call. Such a web site includes a searchable registered business directory, a space for businesses to post their profile(s), rich media content, install fully interactive web applications, and web software necessary for customers to initiate instant calls to an RMITD.

Web server systems are any of an entry site or an information site. Entry sites can be directories of searchable registered customer entries. Information sites can be customer profiles, rich media content, or fully interactive web applications. Software for initiating communication with a desired entry site is primarily stored on the host server and accessible by users. Each customer entry has a contact telephone number for communication with the interactive telephone device. Selection of the contact telephone numbers simultaneously enables access to a RMITD's processor and telephone contact with the customer.

A method for rich media enabled communication includes accessing a directory of businesses, locating a rich media enabled contact number corresponding to a business in the directory and dialing the rich media enabled contact number, establishing a telephonic and data connection; and displaying media content associated with the business. Screen sharing between the business and a caller is initiated simultaneously with establishing the telephonic and data connection.

Dialing the rich media enabled contact number occurs on an interactive telephonic device that is selected from the group consisting of a tablet computer, an audio receiving and transmission device, a processor, a display, an input keyboard, and a smart phone device.

A process or method of the subject matter includes as many of the following steps as desired:
1. Caller/customer visits the server web site via a web browser, or executes a mobile software application which links to the server web site.
2. Caller searches for and locates a business he wants to contact.
3. Caller locates the RMITD ID for the business.
4. Caller enters certain textual information, completes an html form, or launches a Rich Internet Application (RIA) to make interactive choices before calling.
5. Caller initiates a call.
6. RMITD rings.
7. Service representative answers.
8. Textual, video, and interactive content associated with the caller is displayed immediately on the service representative's tablet screen.
9. Service representative conducts voice and fully interactive communication with caller.

FIG. 4 shows less than all of these steps to illustrate that they are not all required for the system to operate properly. For example, it is not required that the RMITD literally ring.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

It will be understood that many additional changes in the details, materials, steps and arrangement of parts, which have been herein described and illustrated to explain the nature of the invention, may be made by those skilled in the art within the principal and scope of the invention as expressed in the appended claims.

I claim:

1. A system for rich media enabled communication comprising:
a service server system;
a rich media enabled interactive telephonic device (RMITD) comprising a browser enabled to access the service server system;
wherein the service server system is configured to initiate a system sharing session automatically upon initiation of a phone call with the rich media enabled interactive telephone device.

2. The system as recited in claim 1 wherein the interactive telephonic device is a device selected from the group consisting of a tablet computer, an audio and visual receiving and transmission device, a processor, a display, an input keyboard, and a smart phone device.

3. The system as recited in claim 1, wherein the browser is downloaded from a remote server.

4. The system as recited in claim 1, wherein the service system is a web service system configured as at least one item selected from the group consisting of: a directory server for locating entries, a switchboard for routing communication, a database of directory information, and a host of websites comprising the directory information.

5. The system as recited in claim 4, wherein the system sharing session comprises remote access by the service system of the RMITD's processor.

6. The system as recited in claim 4,
wherein the websites comprise an entry site, information sites, and software for initiating communication with a desired entry site;
wherein the entry site comprises the directory of a plurality of searchable registered business entries,
wherein the information sites comprise business profiles, rich media content, fully interactive web applications, and
wherein the software is primarily stored on a host server and accessible by users.

7. The system as recited in claim 5, wherein each business entry comprises a contact telephone number for communication with the interactive telephone device.

8. The system as recited in claim 7 wherein selection of the contact telephone numbers simultaneously enable access to a business's sever and telephone contact with the business.

9. A system for rich media enabled communication comprising:
a web service server system; and
a rich media enabled interactive telephonic device (RMITD) comprising a browser and an application downloaded and configurable for accessing the web service server system;
wherein the rich media enabled interactive telephone device is configured to initiate a screen sharing session automatically upon initiation of a phone call with the web service server system.

10. The system as recited in claim 9 wherein the interactive telephonic device is selected from a tablet computer, an audio receiving and transmission device, a processor, a display, an input keyboard, and a smart phone device.

11. The system as recited in claim 9, wherein the service system is a web service system configured as at least one item selected from the group consisting of: a directory server for locating entries, a switchboard for routing communication, a database of directory information, and a host of websites comprising the directory information.

12. The system as recited in claim 11, wherein the system sharing session comprises remote access by the RMITD of the service system's processor.

13. The system as recited in claim 12,
wherein the websites comprise an entry site, information sites, and software for initiating communication with a desired entry site;
wherein the entry site comprises the directory of a plurality of searchable registered customer entries,
wherein the information sites comprise customer profiles, rich media content, fully interactive web applications, and
wherein the software is primarily stored on the host server and accessible by users.

14. The system as recited in claim 13, wherein each customer entry comprises a contact telephone number for communication with the interactive telephone device.

15. The system as recited in claim 14 wherein selection of the contact telephone numbers simultaneously enable access to a RMITD's processor and telephone contact with the customer.

16. A method for rich media enabled communication comprising:
accessing a directory of businesses;
locating a rich media enabled contact number corresponding to a business in the directory and dialing the rich media enabled contact number;
establishing a telephonic and data connection; and
displaying media content associated with the business;
wherein screen sharing between the business and a caller is initiated simultaneous with establishing the telephonic and data connection.

17. The method as recited in claim 16 wherein dialing the rich media enabled contact number occurs on an interactive telephonic device that is selected from the group consisting of a tablet computer, an audio receiving and transmission device, a processor, a display, an input keyboard, and a smart phone device.
